(19) United States
(12) Patent Application Publication
(10) Pub. No.: US 2014/0151517 A1
(43) Pub. Date: Jun. 5, 2014

(54) Adjustable Keyboard Support

(71) Applicant: Olin James Mapes, Jacksonville, FL (US)

(72) Inventor: Olin James Mapes, Jacksonville, FL (US)

(21) Appl. No.: 14/027,270

(22) Filed: Sep. 16, 2013

Related U.S. Application Data
(60) Provisional application No. 61/732,440, filed on Dec. 3, 2012.

(51) Int. Cl. F16M 11/14

(52) U.S. Cl. CPC F16M 11/14
USPC 248/124.2

(57) ABSTRACT

The present invention describes a new and improved support for a keyboard that retains a keyboard at an angular and spatial location that suits the needs of a user. The keyboard support includes a weighted base, an extendable arm for adjusting the height of the keyboard stand, and a keyboard platform that supports a keyboard or similar shaped electronic device. The extendable arm comprises ball joints on both ends thereof that allow for angular and rotational adjustment of the extendable arm and the keyboard platform. Further provided on the keyboard platform is a high friction or adhesive layer for securing the keyboard, and a ledge that supports the base of the keyboard.

### CROSS REFERENCE TO RELATED APPLICATION

This application claims the benefit of U.S. Provisional Application No. 61/732,440 filed on Dec. 3, 2012, entitled “Portable Keyboard Stand.” The above identified patent application is herein incorporated by reference in its entirety to provide continuity of disclosure.

### BACKGROUND OF THE INVENTION

1. Field of the Invention

The present invention relates to portable keyboard stands. More specifically the invention relates to a keyboard or electronic device support stand that is capable of being maintained at a desired spatial and angular position to provide a suitable level of comfort for a user.

Today we live in a digital age where nearly all children and adults use computers as part of their everyday lives. People use their computers for entertainment, work, and for educational purposes. Because of its many uses, many people are often required to use their keyboards for an extensive amount of time at their home and/or at their place of employment.

Keyboards enable a person to communicate with their computers and are typically placed on a desk or similar surface. The height of the desk surface determines the positioning of the keyboard for the duration of the computer use. Extended use of the keyboard at an uncomfortable position, such as use on a desk surface not accommodated to the user, can lead to soreness and personal injury to the user. Furthermore, typing on a flat surface for an extending period of time can lead to discomfort in the hands and wrists, and attempts to alter one's positioning can lead to discomfort in a user's arms and back.

What is needed is a device that is capable of enabling a computer user to type on a keyboard for extended periods of time without discomfort. To improve ergonomics for a typing user, most people consider repositioning their hands by altering the height of their seat or the level of their armrests; however the angle at which the keyboard lies will eventually lead to discomfort. Another solution is to purchase a new chair in order to compensate for poor keyboard positioning on the desk surface; however the main issue is still the poor positioning of the keyboard relative to the seated user. Still yet another solution is to purchase ergonomic keyboards that are designed to provide a better fit for a user's hands. These keyboards provide a better fit for a user's hands and have a sloped design that is more comfortable; however if a user desires a keyboard at an more upright angular position, the typical keyboard fails to deliver on the user's needs.

There are several devices that attempt to provide a user with an adjustable platform for the placement of a keyboard. These devices are provided in the form of stands that are designed to incline or tilt a keyboard. These devices may be folded flat and pivot upward, have an arm that elevates a keyboard to a new height, or provide a set of short legs that lift an end of the keyboard. The setback of these devices is that they are only adjustable by a few degrees of inclination, and often have difficulty positioning a keyboard at a variety of angles to suit individual needs. Some of the devices also fail to provide a means of retaining a keyboard at these higher angled positions, while at the same time failing to allow for special repositioning of the keyboard beyond mere tilting thereof. What is needed is a device that enables a user to place a keyboard at a proper angle and location that facilitates user comfort, particularly in work environments where ergonomics are critical to long-term health of the user. Furthermore the device should be portable and convenient for use with keyboards as well as with tablets and other touch screen devices the user may desire to support.

The present invention relates to a keyboard support device for supporting a keyboard thereon and for allowing the user to spatially locate the keyboard in an opportune location to support ergonomics. The keyboard support device is portable and includes a weighted base adapted for placement on a desktop, an extendible arm, and a keyboard platform adapted for supporting a keyboard, touchscreen device, or other similar devices and/or books. The device is rotatable at the base and is additionally extendible and rotatable therefrom. The arm includes a first and second ball joint positioned at the base and the keyboard support, respectively. The ball joints are friction fit to their respective attachments, where when either ball joint is rotated at an angle, the friction fit is of sufficient stability to maintain the keyboard platform in place. The device further includes a means maintaining the position of the keyboard while supported on the platform. In this way, the device enables a user to maintain a keyboard at a desired spatial location and angle in order to greatly reduce the discomfort that comes while using a computer for extended periods of time.

2. Description of the Prior Art

Devices have been disclosed in the prior art that relate to keyboard support devices. These include devices that have been patented and published in patent application publications. These devices generally relate to assemblies that lift a keyboard at an angle that is agreeable with the hands of a user. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 4,555,128 to White describes a foldable support stand used as a reading stand or a writing support surface. The device has a base, an upper support portion, a hinge, and a page holder for holding the pages of a book in a manner that enables the reader to view the page. Additionally, the device includes a hole formed in the support portion for receiving and supporting a writing instrument. Although the support device of White is similar in nature and relevant to the present invention, it differs in that it fails to provide an extension arm that is rotatable and extendible in relation to the base of the device.

U.S. Pat. No. 4,568,056 to Lewinski teaches a tilting mechanism for a keyboard that includes two springs located within the keyboard enclosure; wherein one end of the spring is secured within the keyboard enclosure and the other end is configured to move through openings located on the bottom of the keyboard. Each spring is shaped in the form of a foot and includes a plurality of notches on its outer periphery that enable the foot to be locked in place along the notches to provide a height adjustment to an end of the keyboard. However, although the tilting mechanism of Lewinski is similar in nature and relevant to the present invention, it differs in that it fails to provide an extension arm that is rotatable and extendible in relation to the base of the device. Furthermore the tilting mechanism of Lewinski lacks an efficient separation from the keyboard.

U.S. Pat. No. 4,735,394 to Facco teaches an assembly for adjusting the inclination of a keyboard. The assembly includes a keyboard having a base structure on which there is mounted a plurality of keys, and further including a lower portion having feet that are adapted to support the base structure in a way that the angle of inclination is variable with respect to the desktop. While the inclination adjusting keyboard assembly of Facco is similar in nature and relevant to the present invention, it differs in that it fails to provide an extension arm that is rotatable and extendible in relation to the base of the device.

U.S. Pat. No. 5,395,088 to Ginsberg describes a keyboard stand configured to support a keyboard at an elevated height. Additionally the stand may be adjustable at an angle the keyboard is positioned at to better address the needs of the user. However, while the keyboard support of Ginsberg is similar in nature and relevant to the present invention it differs in that it fails to provide an arm that is angularly and lengthwise adjustable with respect to the base of the device.

The present invention relates to a new and improved device for supporting a keyboard. More specifically the present invention is capable of orienting the keyboard in a spatial position that suits the ergonomic needs of the user. The device includes a weighted base section, an extension arm that is rotatable and extendible from the base, and a keyboard support platform that is rotatable with respect to the extension arm. The extension arm includes rotation mechanisms located at either ends of the arm that allow rotation of the arm relative to the base and further allows rotation of the keyboard support surface relative to the extension arm. Additionally, the rotational mechanisms are attached to the base and the support platform by a friction fit that maintains the rotational positions of the arm and support platform in place once positioned. Finally, the keyboard support surface comprises a support medium thereon configured to retain a keyboard in place once it is placed on the keyboard surface platform. The keyboard platform can be made in a variety of shapes including that of a rectangle for supporting a keyboard, and a more squared shape for supporting a tablet or other similar touchscreen device.

In view of the drawbacks of the prior art devices, it is shown that the prior art has several known setbacks and that the present invention is substantially divergent in design elements from the prior art and subsequently it is clear that there is a need in the art for an improvement to existing keyboard support devices. In this regard the instant invention substantially fulfills these needs.

### SUMMARY OF THE INVENTION

In view of the foregoing disadvantages inherent in the known types of keyboard support devices now present in the prior art, the present invention provides a new keyboard support device wherein the same can be utilized for providing convenience for the user when a keyboard support that is rotationally and lengthwise adjustable is desired for spatially locating a keyboard, tablet, or personal article with respect to a seated or standing user.

The keyboard support device of the present invention is designed for those who do not want to be limited to the placement of a keyboard on a flat support surface. The support device includes a weighted base, a keyboard support platform, and an extendible arm that adjoins the base to the keyboard support and is rotatable therebetween.

It is therefore an object of the present invention to provide a new and improved keyboard support device that has all of the advantages of the prior art and none of the disadvantages.

It is another object of the present invention to provide a keyboard support device that includes a ball joint attachment to its base is therefore readily repositionable with respect thereto.

Another object of the present invention is to provide a keyboard support device having an extension arm capable of supporting a keyboard at an elevated height.

Yet another object of the present invention is to provide a keyboard support device having a support medium and support ledge thereon for retaining a keyboard or personal article on the keyboard platform of the device when tilted at near upright angles.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates a view of the preferred embodiment of the keyboard support of the present invention.

FIG. 2 illustrates a view of the preferred embodiment of the keyboard support of the present invention while supporting a keyboard.

FIG. 3A illustrates a side view of the keyboard support of the present invention while the extension arm between the base and keyboard platform is extended.

FIG. 3B illustrates a perspective view of the keyboard support of the present invention while the arm is retracted.

FIG. 4 illustrates an alternative embodiment of the support platform of the present invention while supporting a tablet.

FIG. 5 illustrates a contemplated locking means for the ball joints between the base and extension arm, and the extension arm and platform.

### DETAILED DESCRIPTION OF THE INVENTION

Reference is made herein to the attached drawings. Like reference numerals are used throughout the drawings to depict like or similar elements of the keyboard support. For the purposes of presenting a brief and clear description of the present invention, the preferred embodiment will be discussed as used for supporting a keyboard, tablet, or personal article at a spatial angle and height that best fits the ergonomic needs of a user. The figures are intended for representative purposes only and should not be considered to be limiting in any respect.

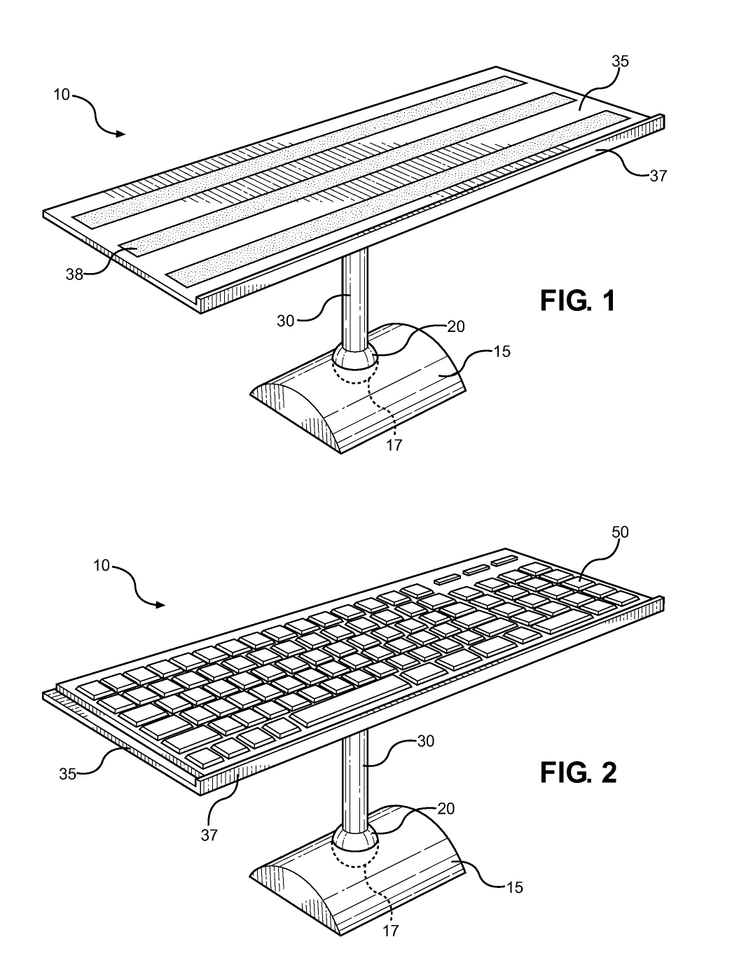

Referring now to FIG. 1, there is shown the keyboard support 10 of the present invention. The keyboard support 10 is configured to support a computer keyboard or other similarly shaped device at an angle and spatial location that suits the ergonomic needs of a user. The keyboard support device 10 includes a weighted base 15 having a cavity 17 thereon adapted to accommodate the attachment of the device arm 30. The device 10 further comprises a support platform 35 configured to aid in retaining a keyboard thereon, and an extendible arm 30 between the weighted base 15 and the support platform 35. The extendible arm 30 includes a ball joint 20 at one end that is rotatably attached to the cavity 17 of the base 15, and further includes an opposing end that rotatably connects to the keyboard support platform 35.

The supporting platform 35 of the present invention is an elongated surface having a lower ledge 37 adapted to prevent an electronic device from sliding therefrom when tilted upright, while further included is a support medium 38 that adds friction and reduces slippage between an electronic device and the support platform 35. The support medium 38 includes strips of material having a high surface friction. The material may be one of a rubber, a plastic material with an adhesive coating, hook and loop fasteners attached to both the bottom of the electronic device and the support platform 35, or any other suitable nonpermanent attachment material.

Referring to FIG. 2, there is shown an illustration of the preferred embodiment of the keyboard support 10 of the present invention while in use. The base 15 of the keyboard support 10 is of a sufficient weight to support the extendible arm 30 and the platform 35 while supporting a device 50 thereon. The ball joint 20 of the extendible arm 30 is frictionally fitted within a cavity 17 along the base 15, wherein at the desired angular orientation of the arm 30, the ball joint 20 remains stationary until acted on by the user. Therefore the weight of the keyboard 50, the platform 35, and further the typing hands of a user are accommodated by the high friction coupling at the ball joint 20 location. A locking mechanism is further contemplated, wherein a set screw (see FIG. 5) can be utilized to lock the position of the ball joint 20. Furthermore, the underside of the base 15 is includes a non-slip material, such as non-slip rubber or another suitable gripping material, in order to maintain its placement on a tabletop when the device 10 is in use.

The platform 35 of the keyboard support device 10 is configured to support a keyboard 50 thereon, wherein when the keyboard 50 is placed on the upper surface of the support platform 35 the keyboard 50 is held in place by the lower ledge 37 and the support material (38 as illustrated in FIG. 1) along the surface of the platform 35. The ledge 37 is of a sufficient height and the support material (38 as illustrated in FIG. 1) is of sufficient friction to maintain the keyboard 50 in place when situated at any of a multitude of height levels and angular orientations that are possible between the angular placement of the extension arm 30 relative to the base 15 of the device 10.

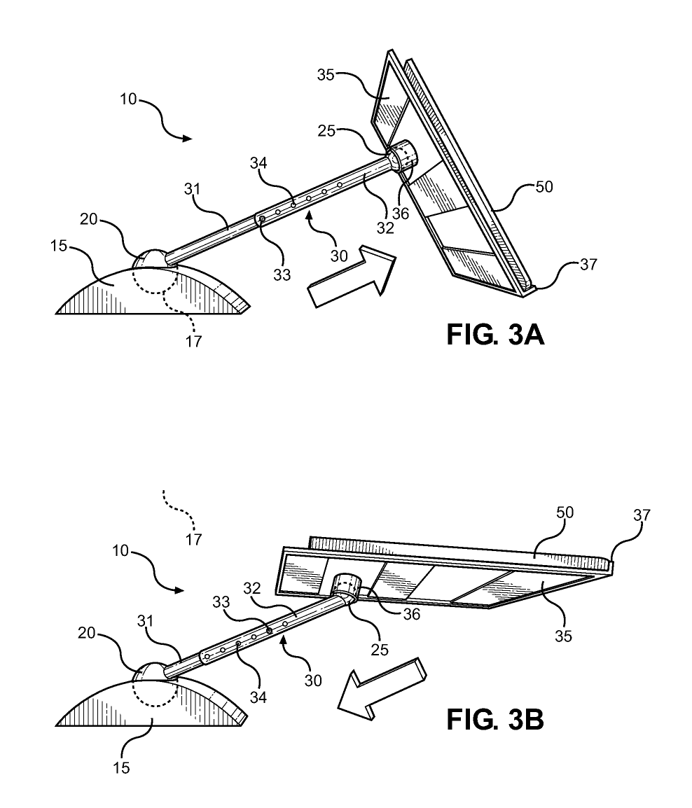

Referring now to FIGS. 3A and 3B, there are shown side views of the keyboard support 10 of the present invention. These views illustrate the keyboard support device 10 having a weighted base 15, a support platform 35, and an extension arm 30 that connects the support platform 35 to the base 15 of the device. Once the extension arm 30 is positioned at an agreeable angular relationship with the base 15, the friction fitting between the ball joint 20 of the extension arm 30, and the cavity 17 of the base 15 maintains the extension arm 30 in place until acted upon by the user.

Similar to that of the first ball joint 20, the proximal end of the extension arm 30 comprises a second ball joint 25. The proximal end of the extension arm 30 comprises a ball joint 25 inserted inside a collar 36 located on the underside of the keyboard support platform 35. Furthermore, the second ball joint 25 is similar to that of the first ball joint 20 in that it comprises a friction fit with the collar 36 or set screw locking means. A contemplated friction fitting between the second ball-joint 25 and the collar 36 is of sufficient tolerance that the angular position of the support platform 35 is supported when orientated relative to the extension arm by the user, wherein the support platform 35 remains at its angular orientation until acted at on by the user. A set screw locking means adds to this connection by preventing rotation at this joint until the set screw is withdrawn. It is contemplated that a first and second set screw having a winged configuration may be deployed for the user to operably lock and unlock the ball joints to free rotation, wherein the set screw requires no tools to advance or retract.

When the platform 35 is positioned in an angular relationship with respect to the extension arm 30 and base 15 of the device 10, the support material and lower ledge 37 of the platform 35 support the article placed thereon. As illustrated in FIG. 3A, when the keyboard 50 rests on the keyboard support platform 35 at a near upright angle, the ledge 37 is configured to prevent the keyboard 50 from falling from the platform 35. Meanwhile, the support material on the platform is configured to reduce slippage or shifting of the article on the platform 35 when in use.

Referring still to FIGS. 3A and 3B, the preferred embodiment of the keyboard support 10 of the present invention includes an extendible arm 30. The arm 30 can both extend and retract in a telescoping relationship as illustrated by the arrows of FIGS. 3A and 3B, respectively. The extendible arm 30 includes a first rod 31 and second rod 32 that are slidably connected to each other in a telescoping relationship and are securable at given positions along rod 32. The first rod 31 comprises a spring pin 33 that is insertable within the second rod 32, which includes a plurality of apertures 34 thereon. The pin 33 includes a spring bias that forces the pin 33 outward; however when the pin 33 pressed inward, there is enough room to permit the insertion and removal of the first rod 31 from the second rod 32.

To extend or retract the extension arm 30, first the pin 33 of the first rod 31 is pressed downward to a position wherein the pin is no longer extending into one of the plurality of apertures 34 of second rod 32. Then the second rod 32 is free to move up or down a place along the first rod 31 until the pin 33 of first rod 31 reaches the next aperture 34 along the plurality of apertures 34 of the second rod 32. The step of pushing the pin 33 of the first rod 31 downward in order to enable the movement of the second rod 32 is repeated until the desired length of the extension arm 30 is achieved.

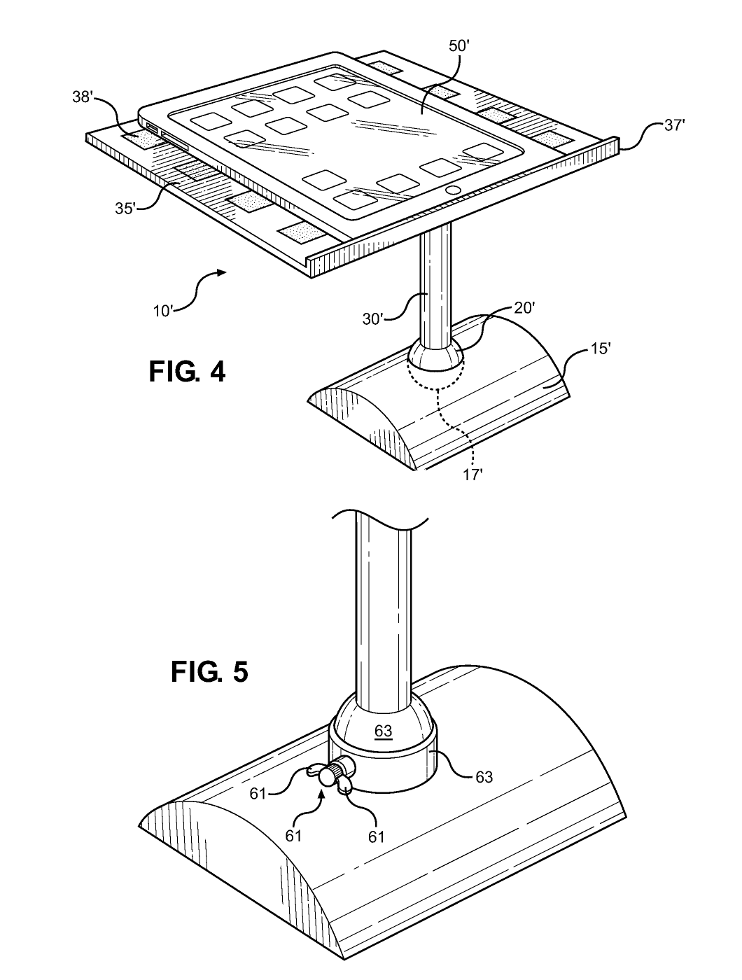

Referring now to FIG. 4, there is shown an alternative embodiment of the keyboard support device 10 of the present invention. The embodiment of FIG. 4 is similar to that of FIGS. 1-3, however this embodiment 10′ is sized to support touchscreen devices and other articles, such tablet computer 50′ and books. As with the preferred embodiment, this embodiment includes a weighted base 15′, a support platform 35, and an extension arm 30′ that is rotatably connected to the base 15′ and to the platform 35′. Similarly, the weighted base 15′ includes a cavity 17′ for containing the first ball joint 20′ of the extension arm 30′ and the support platform 35′ includes a collar (36′, not shown) for containing the second ball joint (25′, not shown) on an opposing end of the extension arm 30′. Furthermore, the tablet support platform 35′ includes a ledge 37′ for keeping the touchscreen device 50′ from falling from the platform 35′ when at a near upright angle with respect to the base 15′ and extension arm 30′. Additionally, the platform 35′ also includes support material 38′ thereon for reducing movement and slippage of the personal article 50′ when in use or when situated at an angle with respect to the base 15′ and the extension arm 30′.

Referring now to FIG. 5, there is shown a view of the contemplated locking means of the present invention, which is adapted to secure the first and second ball joints of the extension arm. The locking means includes a set screw 60 that is a threaded member extendable through a collar 63 in the base and the collar of the platform support. The set screw is advanced through a threaded aperture such that the end of the set screw bears against the surface 63 of the ball joint ball, locking the same in position with respect to the collar 63. The collar 63 may be integrated into the cavity of the base or be an upstanding member as illustrated in FIG. 5, however the locking mechanism remains the same. It is preferred that the set screw having manual advancement and retraction, wherein winged portions 61 thereon allow for hand tightening and loosening of the screw 60. In this way, the user can position the platform support and tighten the ball joints to ensure secure spatial placement of the platform during use, particularly during typing activities.

The present invention is designed for users who wish to have a more comfortable typing experience. Specifically, the present invention is a keyboard support that is both extendible and angularly adjustable to a desired spatial orientation. The present invention is capable of supporting a keyboard, an electronic device, or a personal article (book, magazine, etc.) at an angle and location that suits the ergonomic needs of a user and further includes a ledge and an support material that reduces the likelihood that the article will move, fall from, or slip out of place when in use by a user. The keyboard support device can be used in the home, office, and outdoors, and can be used to hold a variety of devices, including that of a keyboard, touchscreen devices, books and cellular devices, etc. In this way the keyboard support device of the present invention serves to address the ergonomic needs of a user and provides a greater level of comfort than existing devices.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A spatially adjustable support platform, comprising;
a weighted base, a telescoping arm, and an elongated support platform;
said telescoping arm having a first and second end;
said first end comprising a first ball joint connection to said weighted base and said second end comprising a second ball joint connection to said support platform;
said first and second ball joints adapted to facilitate angular adjustment between said support platform and said weighted base;
said elongated support platform further comprising a lower ledge extending therefrom and an upper surface further comprising a support medium adapted to prevent sliding of articles placed thereon;
said first and second ball joints further comprising a close-tolerance friction fitting that is adapted to maintain a given orientation of said ball joint until user interaction.

2. The adjustable keyboard support of claim 1, wherein said telescoping arm further comprises:
a first and second rod in telescopic relation to one another;
said first rod comprising a spring biased pin;
said second rod comprising a plurality of apertures adapted to accept said pin to lock said first and second rod together in a static arrangement.

3. The adjustable keyboard support of claim 1, further comprising a set screw locking means at said first and second ball joint location adapted to operably secure said ball joint orientation when engaged.

4. The adjustable keyboard support of claim 1, wherein said set screw further comprises winged portions adapted to allow hand tightening thereof.
